(19) United States
(12) Patent Application Publication
(10) Pub. No.: US 2004/0260438 A1
(43) Pub. Date: Dec. 23, 2004

(54) Synchronous voice user interface/graphical user interface

(76) Inventors: Victor V. Chernetsky, Kokomo, IN (US); Mona L. Toms, Carmel, IN (US)

Correspondence Address: DELPHI TECHNOLOGIES, INC., M/C 480-410-202, PO BOX 5052, TROY, MI, 48007, US

(21) Appl. No.: 10/463,733

(22) Filed: Jun. 17, 2003

(51) Int. Cl. G06F 7/00; G09G 5/00; H04B 1/46; G01C 21/30; H04B 1/38; G10L 21/00

(52) U.S. Cl. 701/36; 715/728; 701/211; 455/79; 455/563; 704/275

(57) ABSTRACT

A method of synchronizing a voice user interface (VUI) with a graphical user interface (GUI) includes a number of steps. Initially, a first screen is displayed that has an associated first plurality of voice commands that are available for controlling a first application. Upon receiving an event, a second screen is displayed in response to the event with the second screen being associated with a second application. A second plurality of voice commands, which are available for controlling the second application, are then activated and the first plurality of voice commands are deactivated.

### TECHNICAL FIELD

The present invention generally relates to a voice user interface/graphical user interface and, more specifically, a synchronous voice user interface/graphical user interface.

### BACKGROUND OF THE INVENTION

Voice user interfaces (VUIs) have been implemented within motor vehicles to help drivers control various motor vehicle accessories, e.g., a radio, without looking at the motor vehicle accessory. In this manner, a driver of the vehicle can utilize voice commands to control the motor vehicle accessory and maintain their eyes on the road. For example, a driver may change a track of a compact disc, change a radio station or dial a phone number with a voice command, in a system that includes motor vehicle accessories that are controllable with voice commands. In motor vehicles that have implemented VUIs in combination with graphical user interfaces (GUIs), voice commands have been used as shortcuts to the existing GUIs, but have been separate from the GUIs.

One problem with such systems is that the voice commands are typically transparent to a user. With such systems, in order to ensure that a displayed GUI is appropriate for a given voice command, the user must say a general command to bring a given application GUI into visual focus. For example, the command “radio display” may cause the GUI to display the radio application main menu page. Upon speaking the display command for a given motor vehicle accessory, the application commands for the motor vehicle accessory are then active. That is, upon a user providing the voice input “radio display,” the user can then say other commands, such as “preset 3” or “seek up” without first saying the radio application name, in this case, “radio.”

However, when another event, e.g., a switch actuation, changes the focus of the current application the voice commands associated with what is displayed by the GUI are generally not changed. For example, if the GUI shows the radio application, i.e., the radio application is in focus, and the phone rings or the user presses the phone button, the phone application comes into visual focus, but only the top level voice commands for the system are active. That is, the phone application's commands are not active. This causes inconsistencies in the interface and can confuse a user of the system as to what voice commands are currently active. For such a system to activate an application's voice commands, the user must speak a top level voice command for that application. For example, for the radio application, the user would speak the voice command “radio.” Otherwise, only the top level shortcuts are available.

What is needed is a technique that synchronizes a voice user interface (VUI) and a graphical user interface (GUI).

### SUMMARY OF THE INVENTION

One embodiment of the present invention is directed to a method of synchronizing a voice user interface (VUI) with a graphical user interface (GUI) that includes a number of steps. Initially, a first screen is displayed that has an associated first plurality of voice commands that are available for controlling a first application. Next, upon receiving an event, a second screen is displayed in response to the event with the second screen being associated with a second application. Then, a second plurality of voice commands are activated that are available for controlling the second application and the first plurality of voice commands are deactivated.

This embodiment can also be expanded to encompass GUIs with split-screen or multiple windows capability where multiple applications can be simultaneously viewed as separate windows on the screen (one application in each window). In such cases, the plurality of commands will match the GUI application. If the commands of the window or split screen application are available in the GUI, then those commands will also be available with the VUI.

If the split-screen/window application has a primary window where only one application is active and the other(s) can only be viewed, then the VUI will also match the plurality of GUI commands for the active application and not the viewed application(s).

According to another embodiment of the present invention, the event may include one of a speech input, a manual input and an external input.

The manual input may be initiated by a button assertion and the external input may be initiated by, for example, an incoming phone call. In general, each of the displayed screens may be associated with one of a plurality of vehicle accessories, which may include a radio, a compact disc player an electronic address book, a cellular phone, a climate control and a navigation system.

According to another embodiment of the present invention, a system includes a VUI and GUI that are synchronized. The system also includes a display, an input device, a processor, a microphone and a memory subsystem. The processor is coupled to the display, the input device and the microphone, as well as the memory subsystem. The memory subsystem stores code, which, when executed by the processor, causes the processor to perform a number of steps. Initially, the processor causes a first screen to be displayed on the display, with the first screen having an associated first plurality of voice commands that are available for controlling the first application. Upon receiving an event, a second screen is displayed in response to the event, with the second screen being associated with a second application. Then, a second plurality of voice commands that are available for controlling the second application are activated and the first plurality of voice commands are deactivated (unless a split screen/window GUI is implemented to allow for commands of multiple applications to be activated).

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is an exemplary electrical block diagram of an automotive system implementing a graphical user interface (GUI) and a visual user interface (VUI);

FIG. 2 is an exemplary block diagram of a plurality of software modules for implementing the present invention;

FIG. 3 is a schematic diagram illustrating the synchronization of a GUI and a VUI, according to one embodiment of the present invention; and

FIG. 4 is a schematic diagram illustrating the synchronization of a GUI and a VUI, according to another embodiment of the present invention.

### DESCRIPTION OF THE PREFERRED EMBODIMENTS

According to an embodiment of the present invention, a system and method are disclosed in which active voice commands of a voice user interface (VUI) are synchronized with a graphical user interface (GUI). In this manner, a user can visually determine which voice commands are active at any time by examining what is displayed on the GUI. According to this embodiment, synchronization is accomplished by making active only those commands for the application displayed by the GUI.

An expansion of this embodiment encompasses GUIs which support split-screen or multiple windows where two or more applications may be active.

According to another embodiment of the present invention, if the current application has embedded screens, those commands associated with the embedded screens are also available by linking application commands. For example, if a phone application has call, dial and store commands on one screen and, for the call selection, address book names are on a different screen, the user can say “call address book name” as one command, at which point the GUI then displays the same screen as if the commands were activated through the GUI.

It should be appreciated that, according to the present invention, voice commands and GUI commands may be interchangeable. For example, in an address book application, a user could either say the name of the person or enter the person's name selected from a list of names displayed on the GUI. In both cases, a chosen person is selected and voice commands for this particular screen, for example, “call,” “navigate,” etc., become active. At this sublevel, the user can then say or choose GUI screen application commands.

As another example, if a user switches to the radio application by pressing the radio button or saying a radio voice command, the radio comes into visual focus on the GUI and voice commands for the radio application are activated. In this manner, the user can then say or press “preset 3” to switch the radio to a radio station corresponding to “preset 3. ” If a user switches to the compact disc (CD) application by pressing the CD button, the “preset 3” command is no longer active, as the CD application commands, for example, “track 3,” “next track,” etc. are activated.

Thus, according to the present invention, irrespective of how a user selects a particular application, the voice commands for the application become active and, at the same time, all the global verbal shortcuts for the system are active. Synchronization of the GUI with voice commands associated with an active application mitigates many of the command transparency problems associated with traditional VUIs, as it provides a user with available commands. It should be appreciated that the above-described invention is readily applicable to any radio or mobile multi-media product that has voice recognition capability.

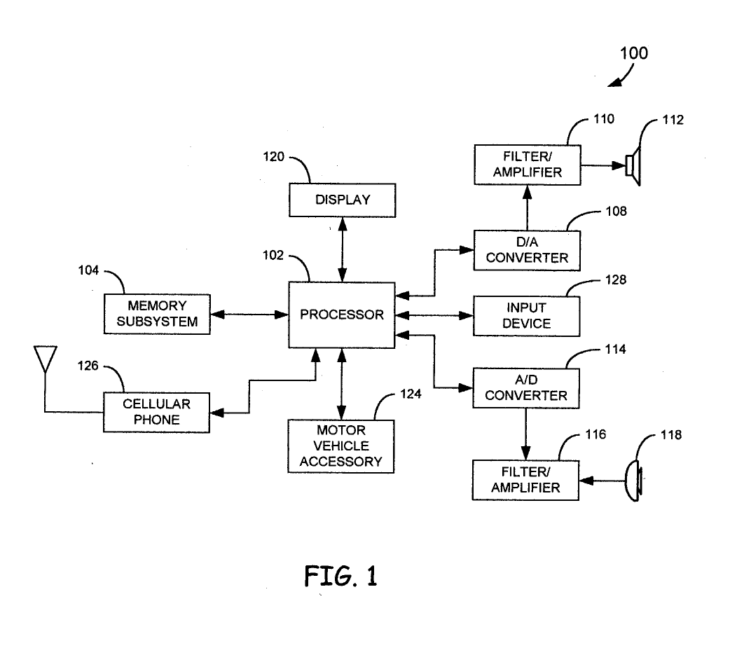

FIG. 1 depicts an exemplary automotive system that implements a GUI and a VUI. The system 100 includes a processor 102 that is coupled to a memory subsystem 104, a display 120 (e.g., a touch display), an analog-to-digital (A/D) converter 114 and a digital-to-analog (D/A) converter 108. The A/D converter 114, which digitizes voice input received by the system 100, is coupled to a microphone 118 via a filter/amplifier 116. The D/A converter 108, which converts digitized voice signals to analog voice signals, is coupled to at least one speaker 112, via a filter/amplifier 110. In this manner, a user of the system can provide voice input through the microphone 118 and receive audio feedback, from the system 100, through the speaker 112.

The processor 102 is also coupled to an input device 128, a motor vehicle accessory 124, e.g., a radio, and a cellular telephone 126. The cellular telephone 126 is one example of a motor vehicle accessory that may be included within a motor vehicle implementing the present invention. The memory subsystem 104 includes an application appropriate amount of volatile and non-volatile memory and is also utilized to store processor executable code that allows the processor 102 to perform a number of steps.

Upon power-up, the processor 102 causes the display 120 to display a first screen, which has an associated first plurality of voice commands that are available for controlling a first application. For example, the first application may be a radio application that is used to control a radio located within the motor vehicle, which may be represented by the motor vehicle accessory 124. Upon receiving an event, e.g., a button input provided through the input device 128 or a speech input received through the microphone 118, the processor 102 causes a second screen to be displayed with the second screen being associated with a second application. For example, the second screen may be associated with the cellular telephone 126. It should be appreciated that the input device 128 and display 120 may be incorporated within a single unit, such as a touch display and/or various input buttons may be positioned around the periphery of the display 120.

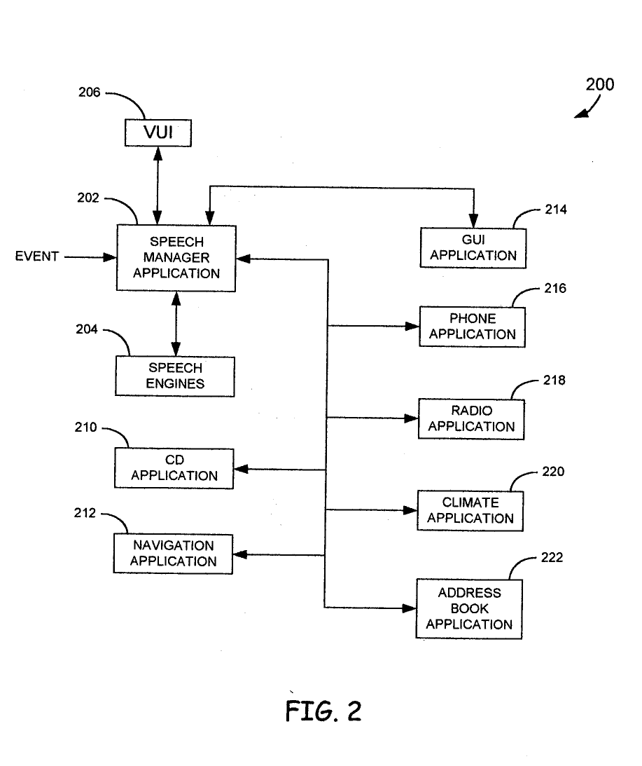

FIG. 2 depicts a block diagram of a plurality of software applications that are utilized to implement the present invention. As is shown in FIG. 2, a VUI application 206 communicates with a speech manager application 202. The speech manager application 202 utilizes various speech engines 204 in determining an appropriate action to take based upon a voice input. The speech manager application 202 is in communication with GUI application 214 and is in communication with a CD application 210, a navigation application 212, a phone application 216, a radio application 218, a climate control application 220 and an address book application 222. Upon receiving an event, which may be, for example, one of a speech input, a manual input and an external input, the speech manager application 202 is called, at which point the speech manager application 202 activates application appropriate voice commands, based upon the event. Then, the speech manager application 202 sends commands to the GUI application 214 to activate appropriate screens. As previously discussed, each high level screen may have a plurality of imbedded screens associated therewith.

As an example, when the TUNER (radio) screen is in visual focus and a user verbally provides the ‘CD’ command, the cd_command( ) routine is called. The cd_command( ) routine sends the ActivateScreen( ) command to the GUI application 214. Next, the CD screen is brought into visual focus on the display 120. Then, the GUI application 214 calls the ActivateScreenNotification routine with information about what particular screen is to be brought into visual focus. In this case, the CD_SCREEN_MGR screen. The ActivateScreenNotification routine handles the visual command and speech manager application 202 state machine for a particular screen. In this case, the voice rule “<cd-top>” is active.

As another example, when the TUNER (radio) screen is in visual focus and a user asserts the CD button, the CD screen is brought into visual focus. Next, the GUI application calls the ActivateScreenNotification routine with information about what particular screen is to be brought in visual focus. In this case, the CD_SCREEN_MGR screen is brought in focus. The ActivateScreenNotification handles the visual command and Speech Manager state machine for a particular screen and the voice rule “<cd_top>” is active.

Set forth below is exemplary code for executing the above-described tasks.

// The function is called whenever a user provides the “CD”
voice command
// It sends the command to the GUI application to bring the CD
screen into focus
void cd_command(void *_nWords)
{

gui_app->ActivateScreen(CD_SCREEN_MGR);

};
// This is the lookup table, where the voice commands (rules)
corresponds to the certain GUI screen
screen_rule_t screen_rules[] =
{// Collection ID | Screen ID | Modal | Rule | SM State

TUNER_SCREEN_MGR, DONT_CARE_ID, 0,

“<radio_top>”, SG_RD_STATE},

{CD_SCREEN_MGR, DONT_CARE_ID, 0,

“<cd_top>“, SG_CD_STATE},

{PHONE_SCREEN_MGR, DONT_CARE_ID, 0,

“<phone_top>”, SG_PH_STATE},

ADBK_SCREEN_MGR, SCR_09_12, 0,

“<ab_command>”, SG_AB_NAME_STATE},

{ADBK_SCREEN_MGR, SCR_09_13, 0,

“<ab_call_command>”, SG_AB_CALL_STATE},

{ADBK_SCREEN_MGR, SCR_09_00, 0,

“<ab_top>”, SG_AB_STATE},

{ADBK_SCREEN_MGR, SCR_09_02, 0,

“<digits_top>”, SG_AB_DIGITS_STATE},

{ADBK_SCREEN_MGR, DONT_CARE_ID, 0,

“<ab_top>”, SG_AB_STATE},

{LAST_ID, DONT_CARE_ID, 0, “”,

DONT_CARE}
};
//This function gets called whenever the GUI screen changes
the visual focus.
//It looks to the lookup table above. If necessary, it activates
certain voice commands
//and changes the Speech Manager state machine.
void ActivateScreenNotification(int collection_id, int screen_id,
int is_modal)
{

int i = 0;
while(screen_rules[i].collection_id != LAST_ID)
{

if(collection_id == screen_rules[i].collection_id)
{

if ((screen_id == screen_rules[i].screen_id) ||

(screen_rules[i].screen_id == DONT_CARE_ID))

{

if(is_modal == screen_rules[i].is_modal)
{

strcpy(voice_focus, screen_rules[i]. rule);
NetRadioSMPreprocessor::getInstance( )-

>deactivate_rules(
NetRadioSMPreprocessor::getInstance( )-
>GetToDeactivateRules( ) );

NetRadioSMPreprocessor::getInstance( )-

>activate_rules(
voice_focus);

if(screen_rules[i].sm_state != DONT_CARE)

{

NetRadioSMPreprocessor::
getInstance( )->SetState(

screen_rules[i].sm_state);

}

return;

}

}

}
i++;

}
strcpy(voice_focus, “<app_commands>”);
NetRadioSMPreprocessor::getInstance( )->deactivate_rules(

NetRadioSMPreprocessor::getInstance( ) -

>GetToDeactivateRules( ) );

NetRadioSMPreprocessor::getInstance( )->activate_rules(

voice_focus);

NetRadioSMPreprocessor::getInstance( )->SetState(
TOP_STATE);

}

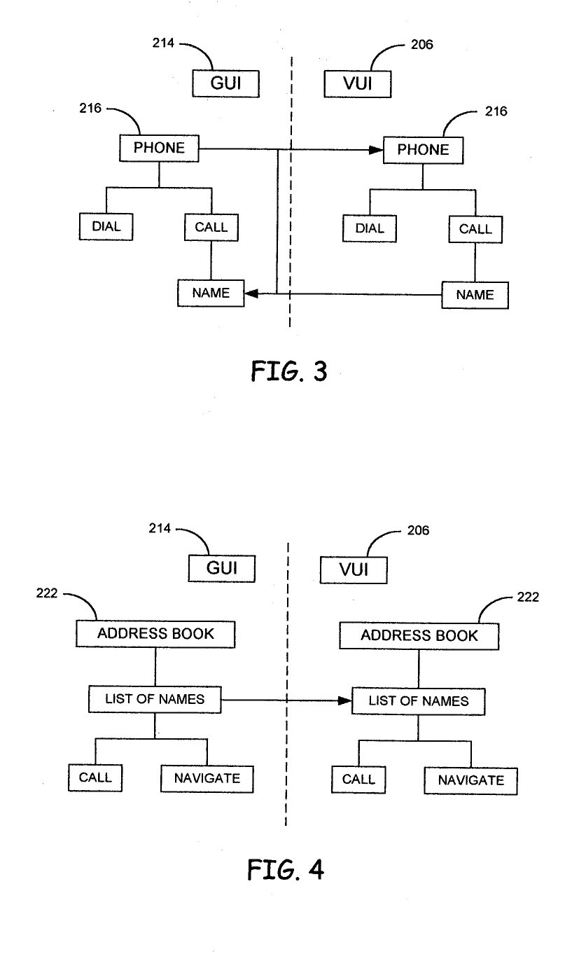

With reference to FIG. 3, if a user presses the “phone” button, the phone application 216 voice commands become active. At that point, when a user provides the voice command “call<name>” the “phone call<name>screen is activated. With reference to FIG. 4, when the address book application 222 is active and a user manually selects a person from the “list of names” screen, the voice commands for the particular person are then active. That is, the user can then verbally provide the voice “call,” to initiate a phone call to the person, or the voice command “navigate” to be provided with instructions on how to travel to the person's residence.

Accordingly, a method and system have been described herein that synchronizes a VUI with a GUI. Thus, whether an external input or a manual input, such as a button input, is utilized to switch an application, an appropriate display is provided and an appropriate plurality of voice commands are activated.

1. A method of synchronizing a voice user interface (VUI) with a graphical user interface (GUI), comprising the steps of:
displaying a first screen that has an associated first plurality of voice commands that are available for controlling a first application;
receiving an event, wherein a second screen is displayed in response to the event, and wherein the second screen is associated with a second application;
activating a second plurality of voice commands that are available for controlling the second application; and
deactivating the first plurality of voice commands.

2. The method of claim 1, wherein the second plurality of voice commands includes at least two linked commands.

3. The method of claim 1, wherein the event is one of a speech input, a manual input and an external input.

4. The method of claim 3, wherein the manual input is initiated by a button assertion.

5. The method of claim 3, wherein the external input is initiated-by an incoming phone call.

6. The method of claim 1, wherein each of the screens is associated with one of a plurality a vehicle accessories.

7. The method of claim 6, wherein the vehicle accessories include a radio, a compact disc player, an electronic address book, a cellular phone, a climate control and a navigation system.

8. The method of claim 1, wherein each of the screens has at least one associated embedded screen.

9. The method of claim 8, wherein the at least one associated embedded screen is accessible by linked commands.

10. The method of claim 1, further including the steps of:
receiving a second event, wherein a third screen is displayed in response to the second event, and wherein the second event is associated with a third application;
activating a third plurality of voice commands that are available for controlling the third application; and
deactivating the second plurality of voice commands.

11. The method of claim 1, wherein the first screen is a default screen.

12. A system including a voice user interface (VUI) that is synchronized with a graphical user interface (GUI), the system comprising:
a display for graphically displaying information;
an input device;
a processor coupled to the display and the input device;
a microphone coupled to the processor, the microphone for receiving a voice input provided by a user;
a memory subsystem coupled to the processor, the memory subsystem storing code which when executed by the processor causes the processor the perform the steps of:
displaying a first screen on the display, wherein the first screen has an associated first plurality of voice commands that are available for controlling a first application;
receiving an event, wherein a second screen is displayed in response to the event, and wherein the second screen is associated with a second application;
activating a second plurality of voice commands that are available for controlling the second application; and
deactivating the first plurality of voice commands.

13. The system of claim 12, wherein the second plurality of voice commands includes at least two linked commands.

14. The system of claim 12, wherein the event is one of a speech input, a manual input and an external input.

15. The system of claim 14, wherein the manual input is initiated by a button assertion.

16. The system of claim 14, wherein the external input is initiated by an incoming phone call.

17. The system of claim 12, wherein each of the screens is associated with one of a plurality a vehicle accessories.

18. The system of claim 17, wherein the vehicle accessories include a radio, a compact disc player, an electronic address book, a cellular phone, a climate control and a navigation system.

19. The system of claim 12, wherein each of the screens has at least one associated embedded screen.

20. The system of claim 19, wherein the at least one associated embedded screen is accessible by linked commands.

21. The system of claim 12, wherein the code when executed causes the processor to perform the additional steps of:
receiving a second event, wherein a third screen is displayed in response to the second event, and wherein the third screen is associated with a third application;
activating a third plurality of voice commands that are available for controlling the third screen; and
deactivating the second plurality of voice commands.

22. The system of claim 12, wherein the first screen is a default screen.

23. An automotive system including a voice user interface (VUI) that is synchronized with a graphical user interface (GUI), the automotive system comprising:
a display for graphically displaying information;
an input device;
a plurality of motor vehicle accessories;
a processor coupled to the display, the input device and the motor vehicle accessories;
a microphone coupled to the processor, the microphone for receiving a voice input provided by a user;
a memory subsystem coupled to the processor, the memory subsystem storing code which when executed by the processor causes the processor the perform the steps of:
displaying a first screen on the display, wherein the first screen has an associated first plurality of voice commands that are available for controlling a first application;
receiving an event, wherein a second screen is displayed in response to the event, and wherein the event is associated with a second application;
activating a second plurality of voice commands that are available for controlling the second application; and
deactivating the first plurality of voice commands, wherein each of the screens is associated with one of the motor vehicle accessories.

24. The system of claim 23, wherein the second plurality of voice commands includes at least two linked commands.

25. The system of claim 23, wherein the event is one of a speech input, a manual input and an external input.

26. The system of claim 25, wherein the manual input is initiated by a button assertion.

27. The system of claim 25, wherein the external input is initiated by an incoming phone call.

28. The system of claim 23, wherein the vehicle accessories include a radio, a compact disc player, an electronic address book, a cellular phone, a climate control and a navigation system.

29. The system of claim 23, wherein each of the screens has at least one associated embedded screen.

30. The system of claim 23, wherein the at least one associated embedded screen is accessible by linked commands.

31. The system of claim 23, wherein the code when executed causes the processor to perform the additional steps of:
receiving a second event, wherein a third screen is displayed in response to the second event, and wherein the third screen is associated with a third application;
activating a third plurality of voice commands that are available for controlling the third screen; and
deactivating the second plurality of voice commands.

32. The system of claim 23, wherein the first screen is a default screen.
